(19) United States
(12) Patent Application Publication
(10) Pub. No.: US 2006/0200307 A1
(43) Pub. Date: Sep. 7, 2006

(54) Vehicle identification and tracking system

(75) Inventor: Michael J. Riess, Chenango Forks, NY (US)

Correspondence Address: WALL MARJAMA & BILINSKI, 101 SOUTH SALINA STREET, SUITE 400, SYRACUSE, NY, 13202, US

(73) Assignee: Lockheed Martin Corporation, Bethesda, MD (US)

(21) Appl. No.: 11/072,823

(22) Filed: Mar. 4, 2005

(51) Int. Cl. G01C 21/00; G08G 1/00

(52) U.S. Cl. 701/207; 701/117

(57) ABSTRACT

The present invention is directed to an automated vehicle identification and tracking system. The system includes at least one area monitoring system that has a plurality of imaging units disposed in an area. Each imaging unit is configured to capture an image of a monitored vehicle disposed in the area. A control system is remotely coupled to the at least one area monitoring system. The control system is configured to classify and track the monitored vehicle based on anonymous vehicle feature data extracted from the captured image. The system can assimilate eyewitness input concerning a vehicle based on anonymous vehicle feature data, including time and location of the sighting of the target vehicle, wherein the system can effectively identify the current location of candidate target vehicles within the monitored area.

### FIELD OF THE INVENTION

The present invention relates generally to vehicle surveillance, and particularly to a system and method for identifying and tracking vehicles.

### BACKGROUND OF THE INVENTION

Law enforcement agencies, the military, and traffic management agencies, as well as public safety and security organizations recognize the need for an effective wide area traffic surveillance system that is configured to identify, monitor, and track the location and movement of selected vehicles. For example, a manual search by police personnel is often required to locate and track a suspect's vehicle. Because of the ever-increasing police caseload, trying to locate the suspect vehicle days or weeks after the crime is committed becomes problematic. Police resources tend to concentrate on recent events and older cases are essentially forgotten. Further, when a suspect is driving a vehicle, police personnel may give chase to prevent the suspect from escaping. The dangers associated with such high speed chases are obvious—the results may include serious injury or death to the police, the suspect, and/or civilians, in addition to property damage.

From another standpoint, monitoring and tracking vehicles to discover unusual activities and patterns would be of enormous benefit to police and security personnel. For example, in high crime areas a wide area traffic surveillance system could be a useful tool in combating drug trafficking, vehicle theft, and vandalism.

According to one known approach, inductive loop sensors are disposed at various locations on a given roadway. Each loop sensor magnetically senses metallic objects that pass over it. By placing two loops a known distance apart, the speed of a given vehicle may be measured. Thus, inductive loop sensors, according to this concept, may be employed to count vehicles and to measure the speed of passing vehicles. While inductive loop sensors are inexpensive, they can only monitor a relatively small area.

According to yet another approach, an automated traffic surveillance system includes a network of smart sensors. The system is a multi-layer system that includes a sensor layer, an interface layer and several processing layers. The sensor layer may include video and infrared cameras, radar, sonar, and smart magnetic loops that are disposed road side for data collection purposes. The road side sensor interface typically includes only one such sensor per location. The sensors are linked to a multi-sensor advanced tracking system. One drawback to the above described approach is that while it effectively measures traffic flow and incidents of congestion, the system does not have an automated vehicle identification and tracking system that maintains a running database on vehicles traveling through monitored areas.

Therefore, what is needed in the field is an automated vehicle identification and tracking system that provides real-time automated monitoring of specified areas. It would be desirable to provide an automated system for identifying and tracking vehicles that maintains a running database on vehicles traveling through monitored areas. What is also needed is a means for deploying a wide area traffic surveillance system, such that road blocks could be placed without alerting suspects that police are tracking their movements.

### SUMMARY OF THE INVENTION

The present invention addresses the above described needs. The present invention is directed to an automated vehicle identification and tracking system that provides real-time automated monitoring of specified areas. The system detects, identifies, and tracks vehicles that travel through monitored areas. Further, the system of the present invention also maintains a running database on vehicles traveling through monitored areas.

Therefore and according to one aspect of the present invention, there is provided a method for identifying a vehicle, comprising the steps of:
using said at least one sensor to acquire a plurality of data about at least one vehicle in a monitored area;
storing said acquired data in a database;
classifying said at least one vehicle into a classification using said acquired data and storing said classification in said database;
determining a set of candidate vehicles, from said classification in said database, similar to a particular vehicle or vehicle pattern based on a description of said particular vehicle or vehicle pattern; and
providing a user with a list of said set of candidate vehicles.

Preferably, the description is based upon an eyewitness report regarding the particular vehicle sighted at a particular time and location in the monitored area. The method further includes the step of providing the user with a path of each of the candidate vehicles in the monitored area, in which the path intersects the location sighted within a specified range of the time of the sighting.

According to another aspect of the present invention, there is provided a system used for identifying a vehicle, comprising:
means for using said at least one sensor to acquire a plurality of data about at least one vehicle in a monitored area;
means for storing said acquired data in a database;
means for classifying said at least one vehicle into a classification using said acquired data;
means for storing said classification in said database;
means for determining a set of candidate vehicles, from said classification in said database, similar to a particular vehicle or vehicle pattern based on a description of said particular vehicle or vehicle pattern; and
means for providing a user with a list of said set of candidate vehicles.

According to yet another aspect of the present invention, there is provided an automated vehicle identification and tracking system. The system includes at least one area monitoring system that has a plurality of imaging units disposed in an area. Each imaging unit is configured to capture an image of a monitored vehicle disposed in the area. A control system is remotely coupled to the at least one area monitoring system. The control system is configured to classify and track the monitored vehicle based on anonymous vehicle feature data extracted from the captured image.

According to yet another aspect of the present invention, there is provided a method for identifying and tracking vehicles using an automated vehicle identification and tracking system. The system includes at least one area monitoring system and a control system. The at least one area monitoring system has a plurality of imaging units disposed in an area. The method includes the step of capturing an image of a vehicle disposed in the area with at least one of the plurality of imaging units. First anonymous vehicle feature data and first location data are extracted from the captured image. The vehicle is classified based on the anonymous vehicle feature data. The first time/location data and the first anonymous vehicle feature data are stored.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of a particular embodiment of the invention, and are intended to provide an overview or framework for understanding the nature and character of the invention as it is claimed. The accompanying drawings are included to provide a further understanding of the invention, and are incorporated in and constitute a part of this specification. The drawings illustrate various examples of a particular embodiment of the invention, and together with the description serve to explain the principles and operation of the invention.

### BRIEF DESCRIPTION OF THE DRAWINGS

FIG. 1 is a high-level block diagram of the automated vehicle identification and tracking system in accordance with the present invention;

FIG. 2 is a block diagram of the system control system in accordance with one embodiment of the present invention;

FIG. 3 is a plan view of the area monitoring system in accordance with another embodiment of the present invention;

FIG. 4 is a perspective view of an imaging unit in accordance with one embodiment of the present invention;

FIG. 5 is a block diagram of the imaging unit depicted in FIG. 4;

FIG. 6 is a flow chart of the method for identifying and tracking vehicles in accordance with an embodiment of the present invention;

FIG. 7 is a graphic representation of a vehicle identification and tracking template matching process, comparing newly acquired images of a vehicle to previously acquired images of vehicles, according to the present invention;

FIG. 8 is a graphic representation of a vehicle template matching process, comparing the archived template of a particular make, model and year vehicle, to images of vehicles that have been acquired by the system of the present invention;

FIG. 9 is a set of charts and selected images of interest, illustrating the results of searching for a tracked vehicle within a database of logged images in accordance with the present invention;

FIG. 10 is yet another set of charts and selected images of interest, illustrating the results of searching for a tracked vehicle within the database of logged images in accordance with the present invention;

FIG. 11 is yet another set of charts and selected images of interest, illustrating the results searching for a tracked vehicle within the database of logged images in accordance with the present invention; and

FIG. 12 is yet another set of charts and selected images of interest, illustrating the results of searching for a tracked vehicle within the database of logged images in accordance with the present invention.

### DETAILED DESCRIPTION

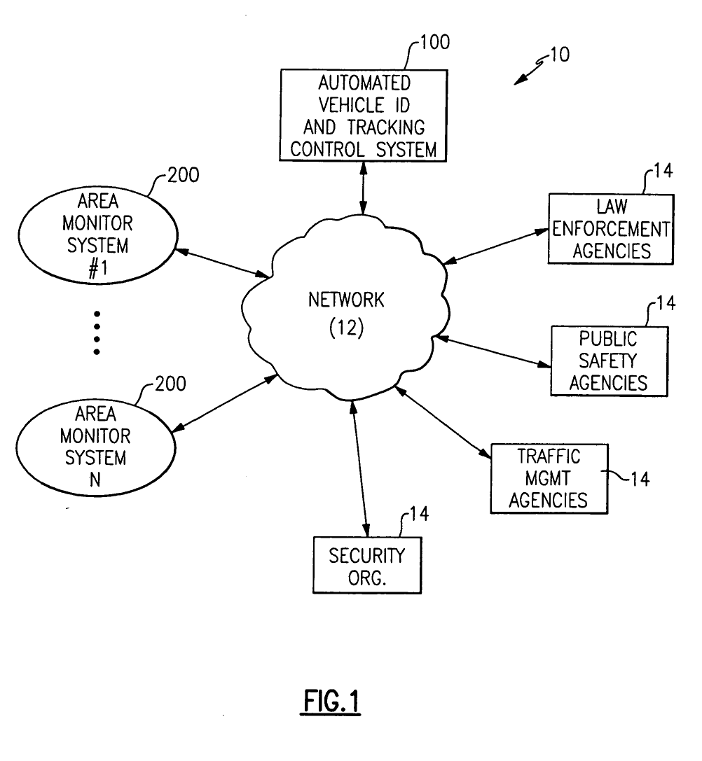

Reference will now be made in detail to the present exemplary embodiment of the invention, examples of which are illustrated in the accompanying drawings. Wherever possible, the same reference numbers will be used throughout the drawings to refer to the same or like parts. The system of the present invention according to the exemplary embodiment is shown in FIG. 1, and is designated generally throughout by reference numeral 10.

In accordance with the invention, the present invention is an automated vehicle identification and tracking system. In brief, the system includes at least one area monitoring system having a plurality of imaging units disposed in an area. Each imaging unit is configured to capture an image of a monitored vehicle disposed in the area. A control system is remotely coupled to the at least one area monitoring system. The control system is configured to both classify and track the monitored vehicle, based on anonymous vehicle feature data extracted from a captured image(s).

As embodied herein, and depicted in FIG. 1, a high-level block diagram of automated vehicle identification and tracking system 10 in accordance with the present invention is disclosed. System 10 includes area monitoring systems 200 which are coupled to control system 100 by way of network 12. As shown, system 10 may accommodate N area monitoring systems 200, N being an integer value. Control system 100 may also be linked to external entities 14, such as law enforcement agencies, public safety agencies, traffic management entities, and/or security entities. System 10 is an effective wide area traffic surveillance system that is configured to identify, monitor, and track the location and movement of selected vehicles and provide this information to external entities 14 for any number of applications. In one embodiment, control system 100 is equipped with a web-interface that allows remote users at entities 14 to access control system 100 data.

In one application, the present invention provides automated location and tracking of a known suspect's vehicle, or a vehicle involved in criminal pursuit. This feature of the present invention reduces the need for dangerous high-speed chases. Because the system provides law enforcement agencies 14 with tracking data, roadblocks may be placed appropriately. Often, chases occur when suspects of a crime become aware of the fact that they are being tracked by the presence of a trailing police vehicle. By deploying a wide area traffic surveillance system, a road block could be placed without alerting the suspects that police are tracking their movements.

In another application, automated long term tracking of vehicles may be used to flag unusual activities and patterns. An example would be a vehicle that frequently enters a monitored area, such as an airport, stadium, governmental facility, interchanges, residential areas, and/or other sensitive or troubled areas, without an apparent reason. For example, the present invention is well suited to monitor an airport terminal where common vehicles would be taxis and busses. A particular make and model of a personal vehicle would not appear nearly as frequently and the frequent presence of such a vehicle would be suspicious.

In yet another application, the present invention may provide automated location and tracking of city resources, from police vehicles to maintenance equipment. In this scenario, the present invention would provide tracking information enabling rapid deployment in an emergency. In this embodiment, other means, such as bar codes, RF tags, or other mechanisms, visual or electronic, may be used to quickly identify and process known resources to allow the system to focus on processing unknown vehicles.

In yet another scenario, the tracking information provides important feed back information helping public safety and traffic management personnel to respond to accidents or traffic congestion. In yet another application, the present invention provides automated identification and tracking of reported stolen vehicles.

In performing the above described missions, the system continually gathers images of vehicles as they pass by the imaging units disposed in the monitored areas. The images are processed in order to identify and/or classify numerous anonymous traits of each vehicle, such as to determine or identify the color of the vehicle, the type and possibly the make and model of the vehicle, and the like. The system may also interact with a face recognition system or alternatively with peripherals, such as speeding or traffic light violation detectors. The present invention may also be used to acquire non-anonymous vehicle data, e.g., license plate characters, by optical character recognition (OCR) techniques. As noted herein, there are numerous jurisdictions wherein this latter activity is a violation of civil rights and cannot be performed. The present invention, however, is not dependent upon this particular application.

As explained in more detail below, the acquired imaging data, and data derived from the imaging data, is uploaded to a central data base system. This database system tracks the progress of each vehicle as it travels through a monitored area. The recognition task for each image collection position is enhanced by the central system by grouping profiles on vehicles that have already been imaged at one area monitoring site, with area monitoring sites that the vehicle is likely to subsequently pass through. This apriori information would enable a vehicle's profile to be more easily identified, as well as refine the reference profile for that vehicle as more images of the vehicle are acquired.

The system of the present invention is relatively inexpensive compared with the manual resources that would be necessary to provide a similar functionality. There is also a significant safety factor in that pursuits and apprehensions can be conducted in a much more predictable fashion. Also, the vigilance of the system would provide the opportunity for a very efficient utilization of the manual resources that are available to a community.

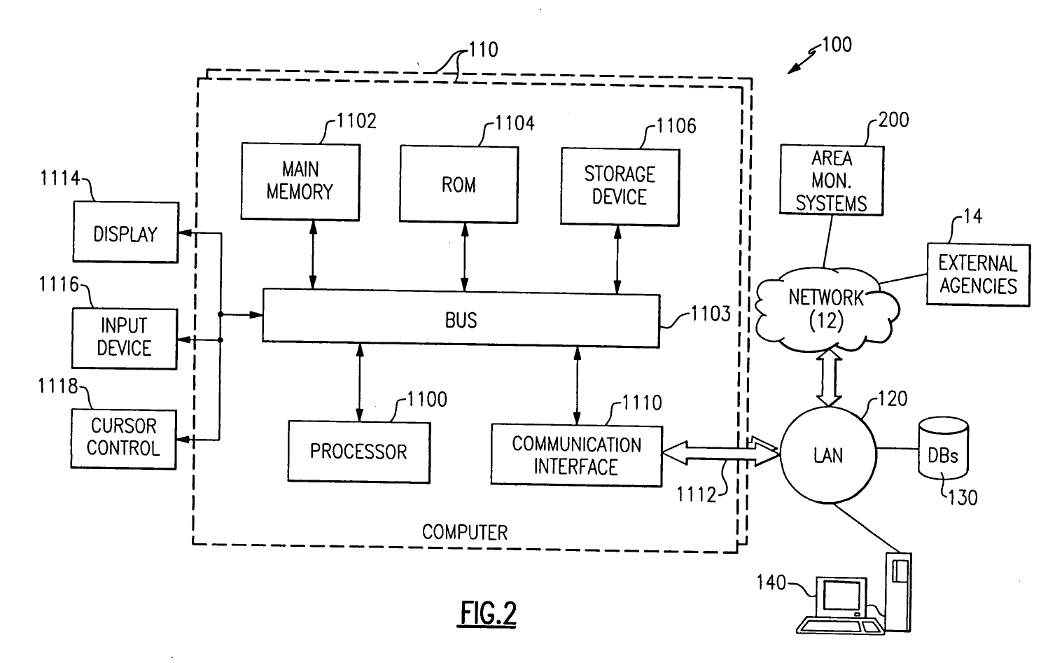

As embodied herein, and depicted in FIG. 2, a block diagram of the control system 100 in accordance with one embodiment of the present invention is disclosed. Control system 100 includes networked computers 110 coupled to local area network (LAN) 120. LAN 120 is also configured to interconnect computers 110, database 130 and server computer 140. In this embodiment, LAN 120 also provides control system 100 with access to an external network 12. As noted above, network 12 is coupled to area monitoring systems 200 and external entities 14.

FIG. 2 also provides implementation details for the interconnected computers 110. Each computer 110, according to this embodiment, is configured to classify and track monitored vehicles based on anonymous vehicle feature data that has been extracted from the images captured by area monitoring systems 200. As shown therein, the computer 110 includes a bus 1108 which is used to interconnect a number of contained components including a processor 1100, RAM (Random Access Memory) 11102, ROM (Read Only Memory) 11104, other storage media 1106 such as, for example, a hard disk or other optical or magnetic media, and a communications interface 1110. The computer 110 may also be coupled via the bus 1108 to a display 1114, an input device 1116, for example, such as a keyboard, and a cursor control device 1118, the latter being a trackball, mouse, or equivalent device. Details concerning the overall operation of the above devices, except where otherwise indicated, is well known in the field and is not the subject of the herein described invention.

As shown in FIG. 2, computer system 110 also includes communication interface 1110 coupled to bus 11108. According to this particular figure, the communication interface 1110 provides a two-way data communication coupling to a network link 1112 that is connected to LAN 1112. In the embodiment shown, communication interface 1110 includes a local area network (LAN) card (e.g. for Ethernet™ or an Asynchronous Transfer Model (ATM) network) to provide a compatible data communication connection to LAN 120. However, those of ordinary skill in the art will recognize that the communication interface 1110 is not limited to the embodiment shown in FIG. 2. For example, the communication interface 1110 may otherwise include, for example, a digital subscriber line (DSL) card or modem, an integrated services digital network (ISDN) card, a cable modem, a telephone modem, or any other communication interface, including wireless links, to provide a data communication connection to a corresponding type of communication line. Although a single communication interface 1110 is depicted in FIG. 2, interface 1110 may include multiple communication interfaces.

The network link 1112 provides data communication between interface 1110 and LAN 120, or to other networks and data devices, depending on the implementation. As shown, network link 1112 connects a number of networked computers 110 to server 140, database 130, and network 12 via LAN 120.

In accordance with the present invention, network 12 may be any type of network including, but not limited to, a wide area network (WAN), the public switched telephone network (PSTN), the global packet data communication network now commonly referred to as the “Internet,” any wireless network, or to data equipment operated by a service provider. LAN 120 and network 12 both use electrical, electromagnetic, or optical signals to carry data and instructions. The signals propagating through communication interface 1110, link 1112, and the various networks, are exemplary forms of carrier waves bearing the information and instructions.

The computer system 110 is configured to send messages and receive data through the network 12, the network link 1112, and the communication interface 1111.

Transmission media may include coaxial cables, copper wires, fiber optics, printed circuit board traces and drivers, such as those used to implement the computer system bus. Transmission media can also take the form of acoustic, optical, or electromagnetic waves, such as those generated during radio frequency (RF) and infrared (IR) data communications.

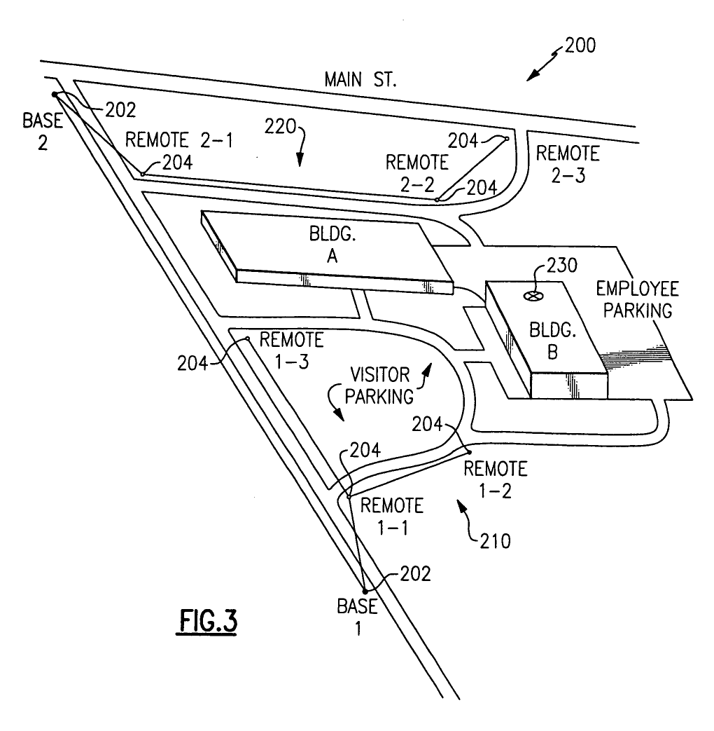

As embodied herein, and depicted in FIG. 3, a plan view of the area monitoring system 200 in accordance with an embodiment of the present invention is disclosed. In this example, area monitoring system 200 is used to monitor a private facility that consists of two proximate buildings. A visitor parking lot is disposed between Building A and Building B. An employee parking lot is disposed behind Building B. Area monitoring system 200 is arranged to monitor vehicles passing by the facility, and those vehicles that enter either one of the parking lots. System 200 includes leg 210 and leg 220. The first leg 210 includes base-1 imager unit 202 and remote imager units (1-1 . . . 1-3) 204. Base-1 unit 202 is coupled to area communications interface 230. Base-1 unit 202 is also coupled to base-2 imager unit 202. The second leg 220 includes base-2 imager unit 202 coupled to remote imager (2-1 . . . 2-3) units 204. Base-2 imager unit 202 is also coupled to area communications interface 230. In one embodiment, the imager devices 202, 204, and the communications interface 230, are interconnected using a line-of-sight wireless communications interface. However, those of ordinary skill in the art will recognize that any of the transmission media described above may be employed. The example depicted in FIG. 3 shows an area monitoring system that is configured to monitor a private facility. Those of ordinary skill in the art will recognize that the present invention may also be configured to monitor public places, such as selected intersections, and/or streets in a residential or commercial area.

Referring to FIG. 4, a perspective view of an imaging unit 204 in accordance with one embodiment of the present invention is shown. Imaging unit 204 includes a digital camera disposed in housing 2054. Housing 2054 is attached to mount 2056, by way of a mounting screw assembly. Mount 2056 may be attached to a tripod, a bracket, or to some other platform. The housing enclosure 2054 includes imaging optics 2040 and trigger mechanism 2052. Housing 2054 also includes a power connector (not shown) for supplying external power to the digital camera electronics. Internal batteries can alternatively be included within enclosure 2054 for operating the electronics. In the embodiment shown, wireless antenna 2050 is coupled to the digital camera. The camera control and image data signals are modulated onto an RF carrier and propagated by antenna 2050. In another embodiment, line-of-sight wireless communications are employed. In yet another embodiment, communications between imaging unit 204 and base imaging unit 202, may be accomplished by means of a modem. Those of ordinary skill in the art will recognize that any of the transmission media described above may be employed, and therefore should not be limited to only those that are described herein.

Imaging unit 204 and base imaging unit 202 are interchangeable units. These units may be configured in the field by actuating a switch mechanism disposed in housing 2054. According to this embodiment, the switch mechanism (e.g., a hardware or software switch) provides a configuration input to the processor. The processor refers to the portion of the control code corresponding to the selection made by the switch mechanism. Any other suitable configuration means can be used, however, between the units.

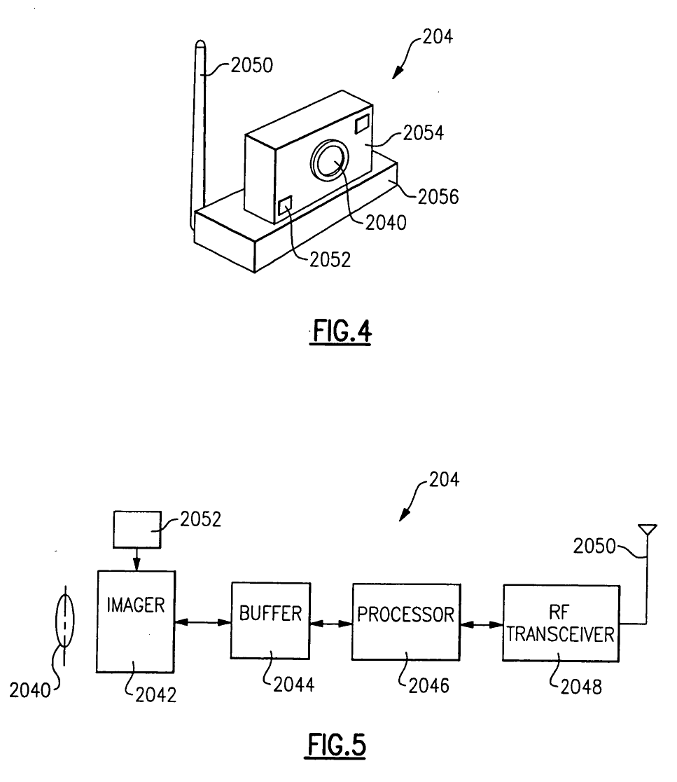

Referring to FIG. 5, a block diagram of the imaging unit 204 depicted in FIG. 4 is disclosed. Imaging unit 204 includes imaging optics 2040, which may include a single lens, or a lens array configured to focus light reflected from a target onto imager assembly 2042. Those of ordinary skill in the art will recognize that the imaging unit can be one of a black and white and a color camera. In the case of the latter, it is within the purview of those within the filed to utilize color filters between imaging optics 2040 and imager 2042 in order to achieve the desired color characteristics. Imager 2042 is coupled to frame buffer 2044. Both the imager 2042 and frame buffer 2044 are coupled to processor 2046. Processor 2046 is also coupled to communications facility 2048. In the embodiment shown, the communications facility includes an RF transceiver connected to antenna 2050. As noted above, it will be apparent to those of ordinary skill in the pertinent art that modifications and variations can be made to communications interface 2048 of the present invention depending on area site considerations, area topography, cost, and other factors. For example, communications interface 2048 may be a line-of-sight system, RF, wireline, fiber optic, infrared, acoustic, or any other suitable means available.

Imager 2042 includes a matrix of photosensitive pixels from line scan to area scan. Those of ordinary skill in the art will recognize that any suitable imager may be employed, including CCD, CID, or other suitable technologies. As is known, the resolution of images produced by imager 2042 is directly related to the density of photosensitive pixels in the array. In one embodiment, imager 2042 is configured to generate a 10 Megabyte image. For purposes of completeness and in the typical “rolling shutter” array, in the instance of a CCD, for example, each line of pixels in the array is exposed sequentially until an entire frame of imaging data is obtained. The frame of imaging data is subsequently read out and stored in frame buffer 2044. In one embodiment, frame buffer 2044 includes flash memory. In another embodiment, the flash memory is augmented by the use of removable memory.

Processor 2046 may be of any suitable type, and may include a microprocessor or an ASIC, or a combination of both. When both are employed, the microprocessor and ASIC are programmable control devices that receive, process, and output data in accordance with an embedded program stored in control memory (not shown. According to this embodiment, the microprocessor 2046 is an off-the-shelf VLSI integrated circuit (IC) microprocessor that provides over-all control of imaging unit 204 as well as the processing of imaging data that is stored in buffer 2044. The ASIC, when employed, may be implemented using any suitable programmable logic array (PLA) device, such as a field programmable gate array (FPGA) device. The ASIC is typically tasked with controlling the image acquisition process, extracting the image features and the storage of image data. As part of the image acquisition process, ASIC performs various timing and control functions, including control of trigger mechanism 2052 and imager 2042.

It will be apparent to those of ordinary skill in the pertinent art that modifications and variations can be made to processor 2046 of the present invention depending on the cost, availability, and performance of off-the-shelf microprocessors, as well as the type of imager 2042 used. In another embodiment, the microprocessor and ASIC combination may be replaced by a single microprocessor. In one embodiment, processor 2046 may be implemented using a single RISC processor. In yet another embodiment, processor 2046 may be implemented using a RISC and DSP hybrid processor.

It will be apparent to those of ordinary skill in the pertinent art that modifications and variations can be made to trigger mechanism 2052 depending on the environment of the area being monitored. For example, trigger mechanism 2052 may include a physical trigger, sonar, radar, a laser, an infrared device, a photosensor, and/or a ranging device. Trigger mechanism 2052 may also be implemented in software by causing imager 2046 to acquire images on a periodic basis. A camera command to acquire a frame is initiated by trigger mechanism 2052. After an image frame is captured, processor 2046 typically extracts anonymous vehicle feature data from the frame. The process of critical feature extraction allows the image data to be compressed from a 10 Mb image into a 10 Kb file. Critical features may include, but are not limited to, an outline of the vehicle, the dimensions, the grill profile, color, body indicia, and/or body damage features. The imaging unit communications interface 2048 is configured to transmit the aforementioned anonymous vehicle feature data to the area system communications interface 230, via base unit imager 202.

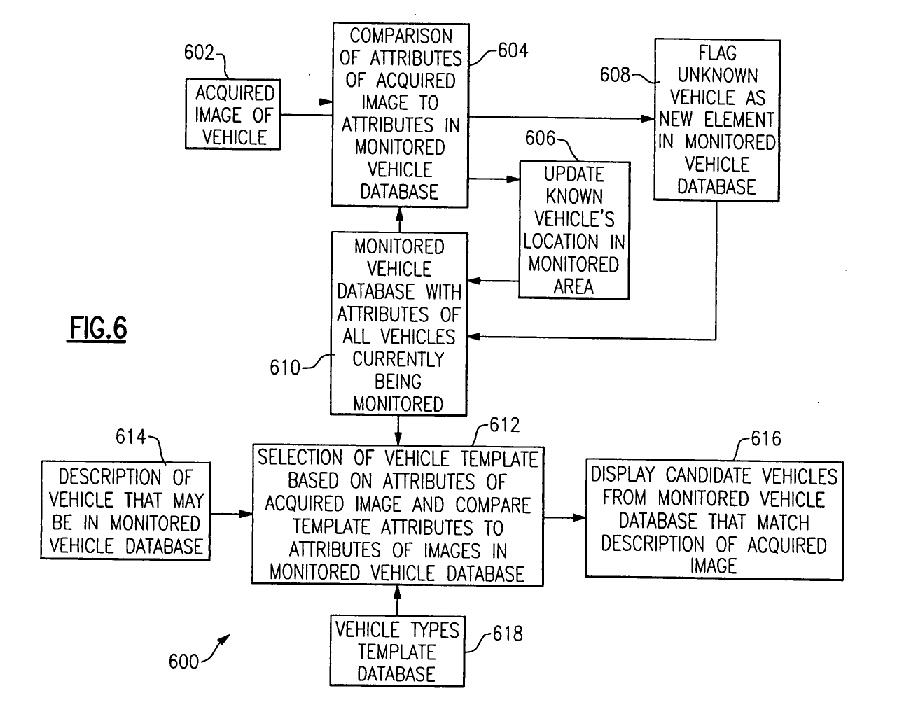

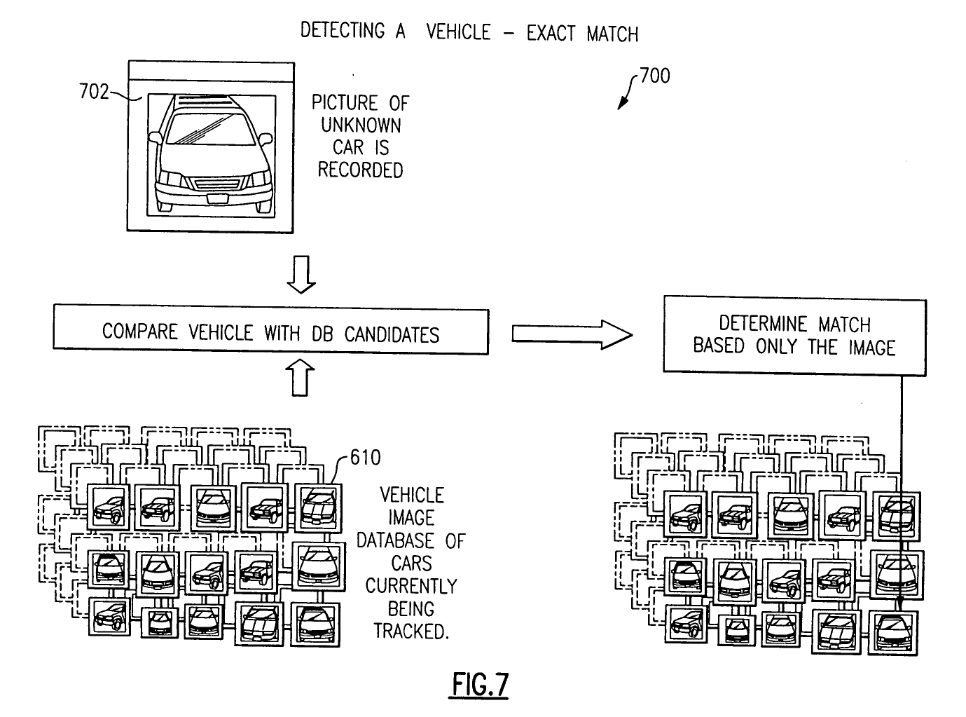

As embodied herein, and depicted in FIG. 6, a flow chart of the method 600 for identifying and tracking vehicles in accordance with the exemplary embodiment of the present invention is disclosed. Before discussing the individual steps of method 600, reference is made to FIG. 2. As noted above, control system 100 is coupled to a database 130. In one embodiment, database 130 includes two separate databases: a vehicle-type template database configured to store vehicle template records, and a tracked or monitored vehicle database. Each vehicle template record corresponds to a predetermined vehicle classification. A vehicle record includes data fields that correspond to predetermined vehicle attributes. Attributes typically include, but are not limited to: vehicle outline data, dimensions, grill profile, and vehicle feature data. These attributes are related to a vehicle make and model, and a vehicle year.

As noted above, the database 130 also includes a tracked or monitored vehicle database which is configured to store tracked vehicle records. Each tracked vehicle record includes data corresponding to the anonymous vehicle feature data that is extracted from a captured image of a previously monitored vehicle, as well as the location and time each image was acquired. Each tracked vehicle record includes several data fields corresponding to the measured tracked vehicle attributes derived from the extracted anonymous vehicle feature data. Like the vehicle-type template database, the tracked vehicle attributes include, but are not limited to: vehicle outline data, dimensions, grill profile, and vehicle feature data. These attributes are related to a vehicle make and model, and a vehicle year. The tracked vehicle record may also include non-standard vehicle feature data, such as missing standard vehicle components, notable non-standard vehicle components that are attached to the tracked vehicle, vehicle body indicia, vehicle damage characteristics, and/or other distinguishing vehicle characteristics.

Referring back to the flow chart of FIG. 6, in step 602 imaging units 204 acquire the image of a vehicle in the manner described above. The critical features are extracted and computers 110, FIG. 2, receive the compressed data via network 12. In step 604, computer 110, FIG. 2, compares the attributes of the acquired image to attributes stored in the tracked vehicle database shown in 610. If a match is found per step 606, the tracked vehicle database 610 is updated by storing the current location of the vehicle in the monitored area, as well as the time the image was captured. If no match is found, computer 110, FIG. 2, designates or “flags” the vehicle as a new element, and the attributes of the newly monitored vehicle are stored in the appropriate fields of the new record in the database 610.

In step 612, computer 110 selects a vehicle template from the template database 618 based on an eyewitness description input 614. According to step 612, a comparison is then run against the vehicle templates that are already stored within the monitored vehicle database 610. The comparison begins with vehicle templates that were generated by the area monitoring systems 200, and that were closest to the specified location and time of the witness sighting. This process continues for either a predetermined tolerance of time and distance or until all vehicles in the tracked vehicle database 610 have been examined. According to step 616, software of the computer 110, FIG. 2, provides an automated presentation of candidate vehicles, that are in the tracked vehicle database 610, exhibiting a high degree of correlation to the eyewitness description of the vehicle along with the time record and likely path to and from the sighting. Therefore, candidate vehicles will be ranked in order of decreasing correlation. The to and from paths for each of these vehicles will also branch into multiple paths as the distance from the location of the sighting increases, since the possibility of similar vehicles intersecting the path of the target vehicle will increase with time and distance. Still, this should result in a significantly smaller number of suspect vehicles to intercept, as opposed to trying to stop all vehicles of this description with an all points bulletin. The ability to place resources ahead of the target vehicles for safe and efficient interceptions optimizes the task even further. Should a target vehicle exit the monitored area, there is at least a starting point; that is, the last monitored position, from which to commence an extended search. Traces back to where the target vehicle may have entered the monitored area, prior to the sighting location, may be helpful as well. Template data and eyewitness data may be stored in the tracked vehicle database 610 if there is a match with a tracked vehicle. Once a tracked or monitored vehicle is classified as being of a certain make, model, year, color, and etc., computer 110 may display candidate vehicles from the tracked vehicle database 610 upon user command.

Referring to FIG. 7, a graphic representation of an example of the vehicle identification and tracking template matching process 700 is depicted. According to this process, a newly acquired image 702 of a vehicle from one of the area monitoring systems 200, FIG. 2, is processed by the feature extraction function and then compared with the features of previously imaged vehicles, in a template format, that are currently being tracked by the system which are stored in the monitored vehicle database 610. This image may or not be compressed in order to effectively extract anonymous vehicle data. Once the best match is determined by means of the above comparison, the new entry is logged as an updated time and location for that particular vehicle. If a match is not found, the vehicle is logged as originating within the monitored area at the location/time and the template is then added to the database 610. It will be apparent to those of ordinary skill in the pertinent art that modifications and variations can be made to the operating system employed by computers 110 depending on the applications and desired operating environment. In one embodiment, a Windows operating system is employed. In another embodiment, a LINUX operating system may be employed. As a non-limiting example, application programs can be written using C, C⁺⁺, Visual Basic, or Visual C⁺⁺. Other languages can be used as well, depending on the application program. In this embodiment, the acquired image captured by imaging unit 204 is decompressed and displayed by GUI 702.

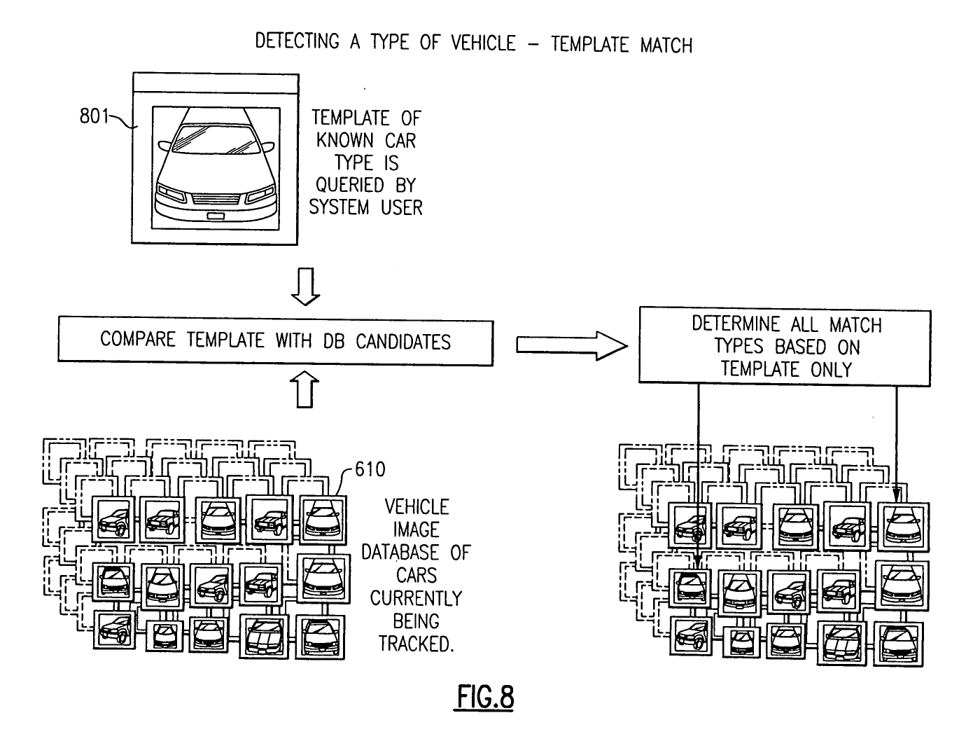

Referring to FIG. 8, a graphic representation of the vehicle template matching process is depicted, comparing the archived template of a particular make, model and year vehicle, to images of vehicles that have been acquired by the system. The template 801 is preferably selected based upon a description provided by an eyewitness. The range of templates 801 will vary from specific makes, models and years to general vehicle types, such as pick-up trucks, vans or compact cars. It is obviously better to have specific information, but general information may be adequate, especially during low traffic volume time periods. The template 801 is then used to determine which candidate vehicles within the monitored vehicle database 610 will be ranked as likely matches given the combination of feature correlation and the relative location of the candidate vehicle at the time of the sighting. As noted above, the acquired image is preferably compressed from 10 Mb to a file of about 10 Kb. This may be accomplished by employing edge detection and image binarization techniques. Reducing the information size allows for easier and faster transmission of only the information necessary for identifying a vehicle, as well as accelerating the correlation process. The need for a more detailed image could be addressed by having the area monitor 200 temporarily log images of the vehicles, such as jpeg compressed images, locally. Once the vehicle is detected by another area monitor system 200, FIG. 2, the logged image of the previous area monitor system 200, FIG. 2, may be overwritten. In this way, a more detailed, human friendly image could be transmitted to the control system 100, FIG. 2, when the need arises without taking up enormous storage resources or transmission band width. However, it may be desirable to equip area monitor systems 200, FIG. 2, located at points where vehicles are leaving the monitored area systems with the capability to handle the logging or transmission of such images.

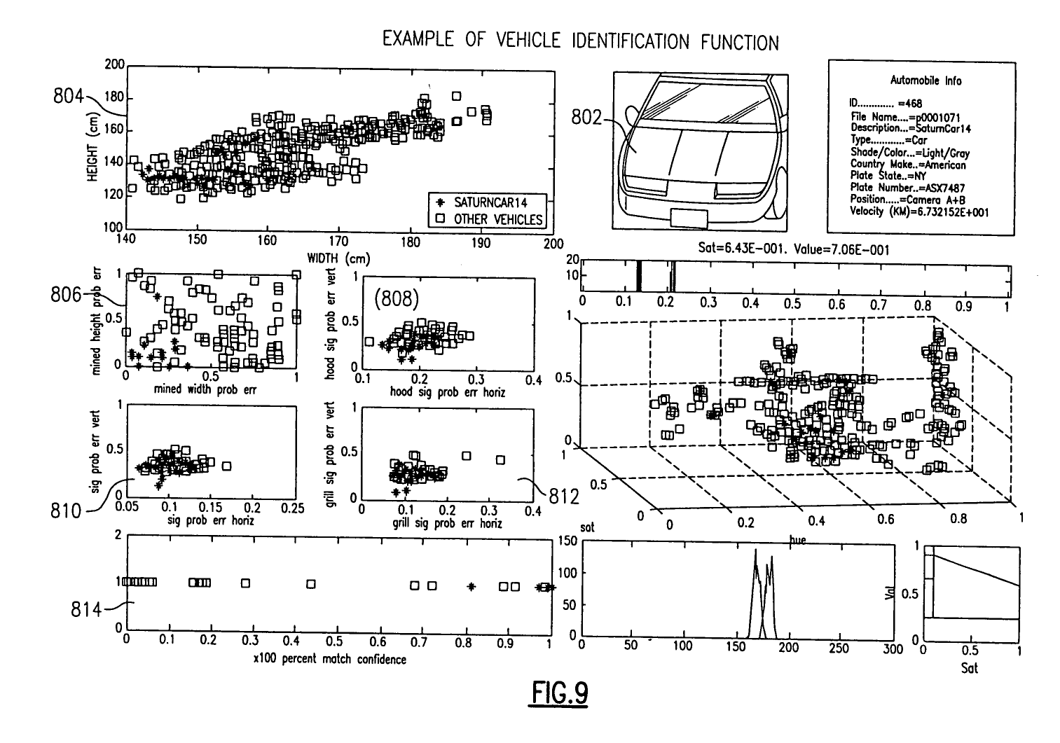

One method of automatically finding a particular vehicle is shown in the examples depicted in FIGS. 9-12. These particular examples were generated by running the application on a data set of about 500 vehicle images in accordance with a method as described in commonly owned and copending U.S. Ser. No. ______ [Attorney Docket 980_{—}012], entitled: Object Recognition System Using Dynamic Length Genetic Training, concurrently filed herewith, the entire contents of which are incorporated in their entirety. The vehicle image data set consisted of more than 130 different vehicles that had each been photographed 2 to 4 times at slightly different angles and magnifications.

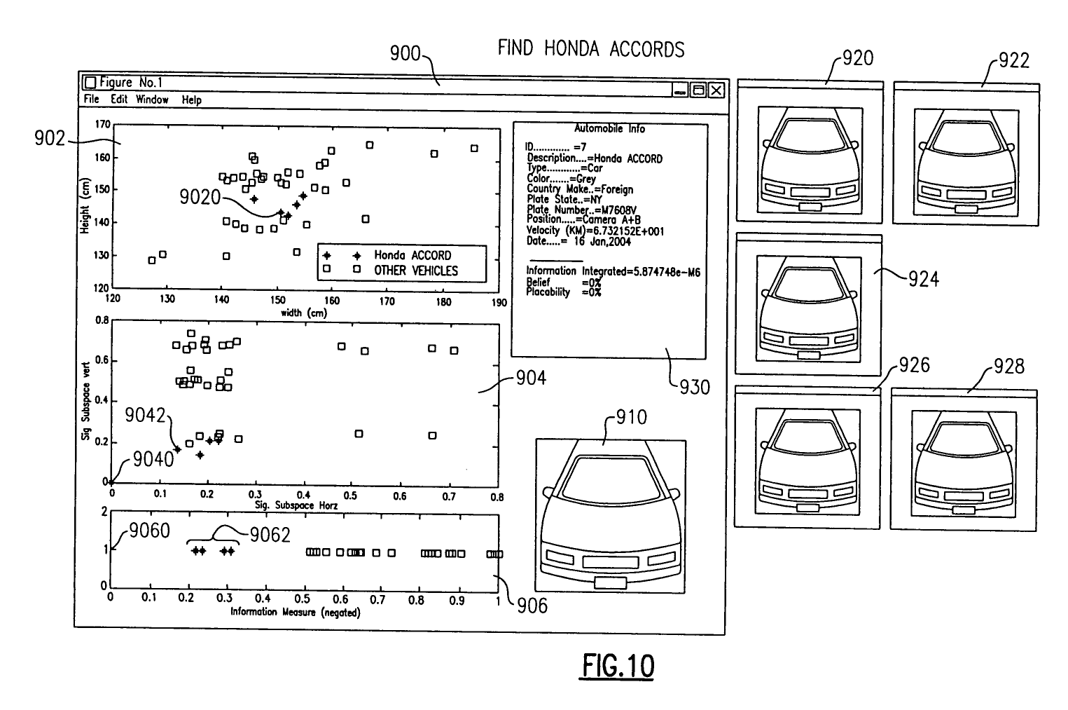

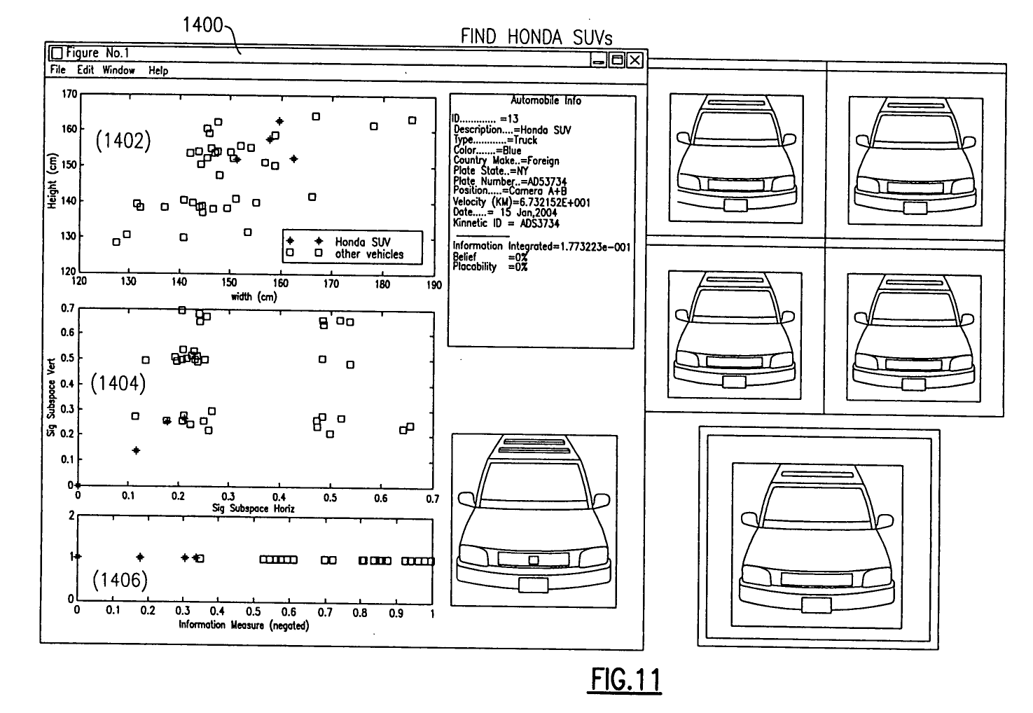

FIG. 9 shows the data points for all 500 vehicle images in each of the intermediate steps, as well as the final result. The target vehicle images are represented as asterisks in plot 804, but are difficult to see in the clutter of all 500 data points. Therefore, although FIGS. 10-12 represent processing that used all 500 vehicle images, a preliminary gross vehicle size filter was used to exclude a large portion of the candidate vehicle images, that would not even come close to correlating with the target vehicle image, so as to show the finer filtering processing more clearly. The plot relates to a specific vehicle shown as 802. As noted, plot 804 represents raw data obtained from a monitored area over a period of time. The horizontal axis and the vertical axis of plot 804 refer to a predetermined feature, such as width and height dimensions respectively. Plots 806, 808, 810 and 812 represent “mined” feature data plots using Tchebysheff's theorem or other means as described in the cross-referenced U.S. Ser. No. ______ [Attorney Docket 980_{—}012] noted above to limit the number of candidate vehicles based upon standard or predetermined region of interest (ROI) rules. In brief, correlation features, temporal features, and linguistic features of each object are compared to the model object, and a fusion score is obtained. A plot 814 is generated that includes a decision distance for each object to determine suitable candidates. Again, details of this exemplary technique are provided in the cross-referenced U.S. Ser. No. ______ [Attorney Docket 980_{—}012] noted above, though other suitable techniques can be utilized. This filtering is described in the above-noted application, previously cross-referenced herein. It should be noted, however, that other suitable means can be utilized, for same.

Each figure illustrates the sequence of operations for culling a particular type of vehicle from the overall population of 500 vehicles. Referring to FIG. 10, Honda Accords are the vehicle type of interest according to this example. Chart 902 displays the gross size comparison, in the horizontal and vertical directions, of the vehicles. Chart 904 displays the cross-sectional correlation comparison, in the horizontal and vertical directions, of the vehicles. Chart 906 is a weighted fusion of the information from the previous 2 charts.

In the set of 500 collected images, five (5) of the images shown as 920, 922, 924, 926, 928 are Honda Accords which are highlighted as asterisks in the charts 902, 904 and 906. 910 represents a sample image which is being matched by the system. Other vehicles that are not Honda Accords are represented as squares. One of these Honda Accord images is used as a reference image for dimensional and sectional profile information. The dimensional and sectional profile information is a description format that significantly reduces the storage space required for the information, while maintaining the unique features of a subject. This concentrated information format also reduces the processing time when comparing numerous subjects. This information is used to identify the other Honda Accord images within the data set even though they are at slightly different viewing angles, magnifications and lighting conditions.

In chart 902, the vehicles are positioned according to width, in the x-axis, and height, in the y-axis. The number of vehicles in chart 902 has been reduced from 500 vehicles to around 40 or 50 vehicles by eliminating vehicles that are outside reasonable tolerance limits of width and height.

The second chart, 904, plots the correlation of profile sections against the stored reference vehicle. The lower left corner 9040 is a perfect vertical and horizontal profile section correlation. The lower the horizontal profile section correlation, the further the data point is moved out in the positive x-axis direction, while the lower the vertical profile section correlation, the further the data point is moved out in the positive y-axis direction.

Inspection of charts 902 and 904 readily indicates that the Honda Accord data points, (e.g., the asterisks 9020, 9040), are not easily segregated from the surrounding data points. However, when the data characteristics of each chart are combined, a more defined separation is achieved, see 9060 in chart 906. This method of combining the separate feature qualities into a one dimensional representation, that enhances grouping of similar elements, is one approach that can be used to anonymously identify vehicles. Inclusion of other features, such as color, connected region analysis, spatial frequency analysis and others would improve the accuracy of the system, but must be traded off with the system's data capacity/bandwidth as well as required throughput and latency requirements.

The above described process may also be employed to provide an automated presentation of candidate vehicles that match an eyewitness description of a vehicle used in a crime. In this embodiment, the number of candidate vehicles may be reduced and ranked in accordance with their similarity to the eyewitness description. The number of candidate vehicles may be reduced by proximity to the location of the crime during a specified period of time. As noted above, the tracked vehicle database stores every known time/location sample of each tracked vehicle.

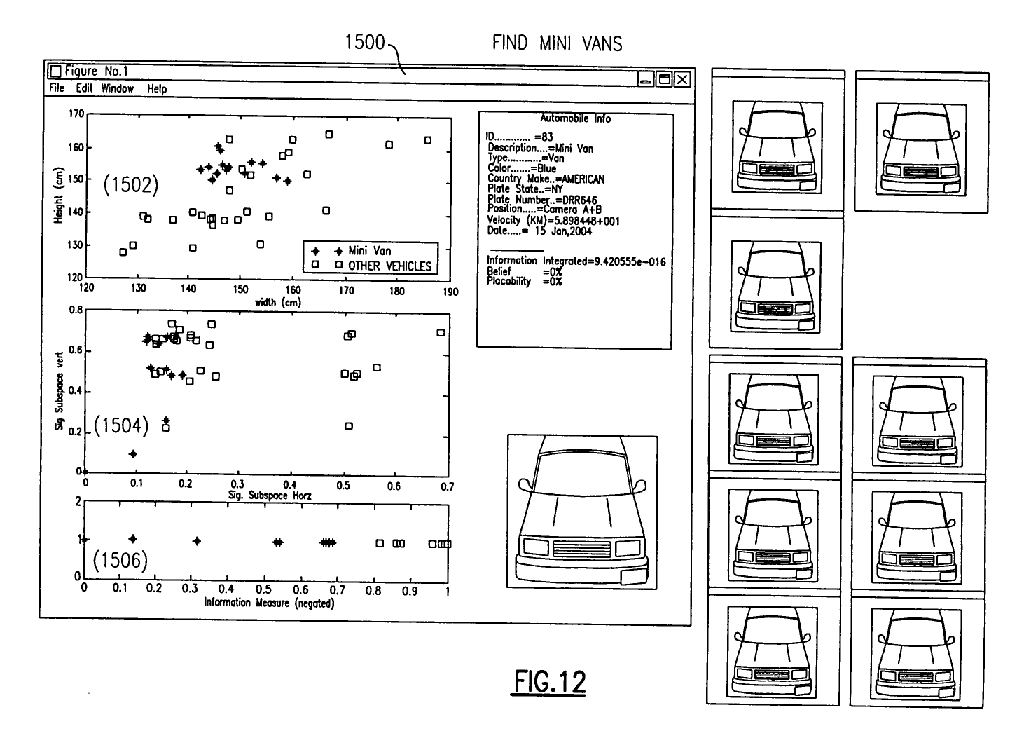

The above described statistical method for determining vehicle matches may be employed for any type of vehicle. For example, FIG. 11 shows the process being repeated for a Honda SUV wherein similar charts 1402, 1404, and 1406 are utilized to indicate the size comparison in the horizontal and vertical directions of the vehicles; the cross-sectional correlation comparison in the vertical directions; and the weighted fusion of the information from charts 1402 and 1404, respectively. FIG. 12 shows the process being used to match a broader class of vehicles, in this instance, mini-vans are selected wherein 1502, 1504 and 1506 relates to the preceding charts for these vehicles.

As noted above, the present invention performs anonymous tracking of vehicles within a monitored area. The term anonymous refers to a method of tracking that does not use license plate or registration indicia. The ability to anonymously track a vehicle because imaging license plates and/or registration data is considered a violation of civil rights in many jurisdictions. Further, eyewitness reports frequently have missing, incomplete, or inaccurate license plate numbers. Finally perpetrators of crimes typically remove or alter license plates before committing the crime.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

We claim:

1. A method for identifying a vehicle, comprising the steps of:
using said at least one sensor to acquire a plurality of data about at least one vehicle in a monitored area;
storing said acquired data in a database;
classifying said at least one vehicle into a classification using said acquired data and storing said classification in said database;
determining a set of candidate vehicles, from said classification in said database, similar to a particular vehicle or vehicle pattern based on a description of said particular vehicle or vehicle pattern; and
providing a user with a list of said set of candidate vehicles.

2. The method of claim 1, further comprising the step of providing said user with a path of each of said candidate vehicles in said monitored area, wherein said description includes a location and time of sighting of said particular vehicle, and wherein each path of said candidate vehicles intersects with said location at said time.

3. The method of claim 1, wherein said description is based on an eyewitness report regarding said particular vehicle sighted at a particular time and location.

4. A method according to claim 1, wherein said description is based on an image of said particular vehicle.

5. A system used for identifying a vehicle, comprising:
means for using said at least one sensor to acquire a plurality of data about at least one vehicle in a monitored area;
means for storing said acquired data in a database;
means for classifying said at least one vehicle into a classification using said acquired data;
means for storing said classification in said database;
means for determining a set of candidate vehicles, from said classification in said database, similar to a particular vehicle or vehicle pattern based on a description of said particular vehicle or vehicle pattern; and
means for providing a user with a list of said set of candidate vehicles.

6. The system of claim 5, further comprising means for providing said user with a path of each of said candidate vehicles in said monitored area, wherein said description includes a time and location of said particular vehicle, and wherein each path of said candidate vehicles intersects with said time and location.

7. The system of claim 5, wherein said description is based on an eyewitness report regarding said particular vehicle, said eyewitness report including time and location information relating to said vehicle.

8. The system of claim 5, wherein said description is based on an image of said particular vehicle.

9. The system of claim 8, wherein said means for storing said classification in said database includes a template containing anonymous vehicle feature data extracted from said image.

10. An automated vehicle identification and tracking system, the system comprising:
at least one area monitoring system including a plurality of imaging units disposed in a monitored area, each imaging unit being configured to capture at least one image of at least one vehicle disposed in the monitored area; and
a control system remotely coupled to the at least one area monitoring system, the control system being configured to classify and track the at least one vehicle based on anonymous vehicle feature data extracted from the captured image.

11. The system of claim 10, wherein the anonymous vehicle feature data includes at least one of standard vehicle feature data and non-standard vehicle feature data.

12. The system of claim 11, wherein the standard vehicle feature data includes at least one of vehicle make data, vehicle model data, vehicle color data, and vehicle year data.

13. The system of claim 11, wherein the non-standard vehicle feature data includes at least one of missing standard vehicle components, extra non-standard vehicle components, vehicle body indicia, vehicle damage characteristics, passenger facial data, and other distinguishing vehicle characteristics.

14. The system of claim 10, wherein the at least one area monitoring system further comprises an area system communications interface, the area system communications interface being configured to communicate with the control system and each of the plurality of imaging units disposed in the area.

15. The system of claim 14, wherein said area communications interface is configured to be coupled to a communications network.

16. The system of claim 14, wherein each of the plurality of imaging units further comprises:
an imager configured to generate a digital signal representative of an image of the vehicle;
a processor coupled to the imager, the processor being programmed to extract the anonymous vehicle feature data from the digital signal; and
an imaging unit communications interface configured to transmit the anonymous vehicle feature data to the area system communications interface.

17. The system of claim 16, wherein the processor is programmed to compress the digital signal.

18. The system of claim 16, wherein each imaging unit further comprises a trigger device coupled to the imager, the imaging trigger being configured to provide the imager with an imaging start signal, the imager being configured to capture an image of the vehicle disposed in the area in response to the imaging start signal.

19. The system of claim 18, wherein the imaging start signal is a periodic signal such that the imager periodically captures an image of the imager field of view.

20. The system of claim 19, wherein the processor is programmed to compare an image frame with a previous image frame to detect the presence of the vehicle.

21. The system of claim 18, wherein the trigger device includes a range detector which provides a signal that indicates whether an object is within the field of view of the imager.

22. The system of claim 10, wherein the at least one area monitoring system transmits area monitor data to the control system, the area monitor data being image data corresponding to the captured image.

23. The system of claim 22, wherein the area monitor data is a compressed version of the captured image.

24. The system of claim 10, wherein the at least one area monitoring system transmits the anonymous vehicle feature data to the control system.

25. The system of claim 10, wherein the control system further comprises:
a vehicle type template database configured to store vehicle template records, each vehicle template record corresponding to a predetermined vehicle classification, each vehicle record including a plurality of data fields, each data field corresponding to a predetermined vehicle attribute;
a tracked vehicle database configured to store tracked vehicle records, each tracked vehicle record including data corresponding to anonymous vehicle feature data extracted from a captured image of a previously monitored vehicle, each tracked vehicle record including a plurality of data fields corresponding to measured tracked vehicle attributes derived from anonymous vehicle feature data; and
at least one computer system coupled to the vehicle type template database and the tracked vehicle database, the at least one computer system including a processor programmed to,
derive measured monitored vehicle attributes from the anonymous vehicle feature data of the monitored vehicle, and
compare the measured monitored vehicle attributes with the plurality of data fields in the tracked vehicle records.

26. The system of claim 25, wherein each said tracked vehicle record further includes time and location data.

27. The system of claim 26, wherein the processor is programmed to flag the monitored vehicle as a new vehicle if the measured monitored vehicle attributes do not correspond to the measured tracked vehicle attributes stored in the tracked vehicle records.

28. The system of claim 26, wherein a new tracked vehicle record is created in the tracked vehicle database, the new tracked vehicle record including a plurality of data fields corresponding to the measured monitored vehicle attributes.

29. The system of claim 28, wherein the new tracked vehicle record includes the time said image was captured and location of said vehicle.

30. The system of claim 27, wherein the measured monitored vehicle attributes are compared to the predetermined vehicle attributes stored in the vehicle template records to thereby classify the monitored vehicle in accordance with one of the predetermined vehicle classifications.

31. The system of claim 26, wherein the processor is programmed to update the location of tracked vehicle if the measured monitored vehicle attributes correspond to the measured tracked vehicle attributes stored in a tracked vehicle record.

32. The system of claim 25, wherein the at least one computer system further comprises:
at least one data input device; and
at least one display device.

33. The system of claim 32, wherein the processor is further programmed to:
compare described vehicle attributes provided via the at least one data input device with the plurality of data fields in the tracked vehicle records; and
display at least one candidate vehicle obtained from the tracked vehicle database if the described vehicle attributes correspond to the measured tracked vehicle attributes stored in the tracked vehicle records.

34. The system of claim 25, wherein the processor is further programmed to select a vehicle template from the template database based upon an eyewitness input description of a predetermined vehicle, said eyewitness input description including the time and location of a sighting of said predetermined vehicle.

35. The system of claim 34, wherein said processor is further programmed to compare the eyewitness input description with stored vehicle templates that are closest to the location and time of the eyewitness input.

36. The system of claim 35, wherein said comparison is continued for a predetermined tolerance of time and/or distance, from said location and time of the eyewitness input description, or until all vehicles in the tracked vehicle database has been examined.

37. The system of claim 35, wherein said processor is further programmed to provide a user with a list of candidate vehicles.

38. The system of claim 37, wherein said processor is further programmed to provide a user with a path of each candidate vehicle in the monitored area, wherein each path intersects with the time and location provided by said eyewitness input description.

39. The system of claim 25, wherein the at least one computer system includes a plurality of computer systems arranged in a network.

40. The system of claim 39, wherein the network includes at least one of a local area network (LAN), a wide area network (WAN), a client-server network.

41. The system of claim 10, wherein the control system includes a communications interface configured to communicate with the at least one area monitoring system.

42. The system of claim 10, wherein the control system is coupled to at least one external entity by a telecommunications network.

43. The system of claim 42, wherein the external entity includes at least one law enforcement or public safety agency, a traffic management agency, or a security system.

44. A method for identifying and tracking vehicles in an automated vehicle identification and tracking system, the system including at least one area monitoring system and a control system, the at least one area monitoring system having a plurality of imaging units disposed in an area, the method comprising the steps of:
(a) capturing an image of a vehicle disposed in the area with at least one of the plurality of imaging units;
(b) extracting first anonymous vehicle feature data and first location image capture time data from the captured image;
(c) classifying the vehicle based on the anonymous vehicle feature data; and
(d) storing the first location data and the first anonymous vehicle feature data.

45. The method of claim 44, further comprising the steps of:
repeating steps (a) and (b) to obtain a second location and second anonymous vehicle feature data;
comparing the first anonymous vehicle feature data to second anonymous vehicle feature data; and
storing the second location data as a current location of the vehicle if the first anonymous vehicle feature data corresponds to the second anonymous vehicle feature data.

46. The method of claim 44, wherein the step of imaging further comprises:
generating a digital signal representative of an image of the vehicle;
extracting the anonymous vehicle feature data from the digital signal; and
transmitting the anonymous vehicle feature data from the imaging unit to the control system.

47. The method of claim 46, further comprising the step of compressing the anonymous vehicle feature data.

48. The method of claim 44, further comprising the step of transmitting area monitor data from the at least one area monitoring system to the control system, the area monitor data including image data corresponding to the captured image.

49. The method of claim 48, wherein the area monitor data is a compressed version of the captured image.

50. The method of claim 44, further comprising the step of transmitting the anonymous vehicle feature data from the at least one area monitoring system to the control system.

51. The method of claim 44, further comprising the steps of:
providing a tracked vehicle database coupled to the control system, the tracked vehicle database being configured to store tracked vehicle records, each tracked vehicle record including data corresponding to anonymous vehicle feature data extracted from a captured image of a previously monitored vehicle, each tracked vehicle record including a plurality of data fields corresponding to measured tracked vehicle attributes derived from anonymous vehicle feature data;
deriving measured vehicle attributes from the anonymous vehicle feature data of the vehicle; and
comparing the measured vehicle attributes with the plurality of data fields in the tracked vehicle records.

52. The method of claim 51, wherein each tracked vehicle record is configured to store the time the image was captured and the location of the vehicle at the time the image was captured.

53. The method of claim 52, further comprising the steps of:
identifying the vehicle as a new vehicle if the measured vehicle attributes do not correspond to the measured tracked vehicle attributes stored in the tracked vehicle records; and
creating a new tracked vehicle record in the tracked vehicle database, the new tracked vehicle record including a plurality of data fields corresponding to the measured vehicle attributes.

54. The method of claim 53, further comprising the step of updating the location of tracked vehicle if the measured vehicle attributes correspond to the measured tracked vehicle attributes stored in a tracked vehicle record.

55. The method of claim 44, further comprising the step of providing a vehicle type template database coupled to the control system, the vehicle type template database being configured to store vehicle template records, each vehicle template record corresponding to a predetermined vehicle classification, each vehicle record including a plurality of data fields, each data field corresponding to a predetermined vehicle attribute.

56. The method of claim 55, including the step of selecting a vehicle template from said vehicle template database based upon an eyewitness input including the time and location of a sighting of a predetermined vehicle.

57. The method of claim 56, including the step of comparing the eyewitness input description with stored vehicle templates that are closest to the location and time of the eyewitness input.

58. The method of claim 57, wherein said comparison step is continued until one of all vehicle records contained in a vehicle tracking database have been examined or a predetermined number of vehicle records based on a specified time and/or distance from the sighting have been examined.

59. The method of claim 58, including the step of providing the user with a list of candidate vehicles which most closely correlate to those provided, based on said comparison.

60. The method of claim 59, including the step of providing the user with a path of each candidate vehicle in the monitored area, wherein each path of each candidate vehicle intersects with the eyewitness location sighting.
